(19) United States
(12) Patent Application Publication
(10) Pub. No.: US 2022/0129209 A1
(43) Pub. Date: Apr. 28, 2022

(54) Advanced Digital Content Processing

(71) Applicants: Dooyong Lee, Seoul (KR); Joseph Nguyen, Newcastle, WA (US); Anuj Arora, Riverside, CA (US)

(72) Inventors: Dooyong Lee, Seoul (KR); Joseph Nguyen, Newcastle, WA (US); Anuj Arora, Riverside, CA (US)

(21) Appl. No.: 17/079,466

(22) Filed: Oct. 24, 2020

(51) Int. Cl. G06F 3/12; G06F 40/103; G06F 40/14; G06F 16/958; G06F 3/041

(52) U.S. Cl. CPC G06F 3/12; G06F 40/103; G06F 3/0412; G06F 16/958; G06F 40/14

(57) ABSTRACT

Techniques are provided to allow a user to select specific criteria for outputting (e.g. printing, displaying, or sending) selected portions of digital content. The digital content is analyzed to determine the type of processing required and user preferences available. The user may then be able to select portions of the document to be included or excluded. The processed digital content is then printed, sent, or displayed to the proper recipients based at least in part on the user selections.

### CROSS-REFERENCE TO RELATED APPLICATION

This application claims priority benefit from U.S. Provisional Application No. 62/926,359 entitled ADVANCED DOCUMENT AND EMAIL PROCESSING and filed on Oct. 25, 2019 by inventors Dooyong Lee and Joseph Nguyen.

### FIELD OF THE INVENTION

The present invention generally relates to enhanced user functionality for outputting for printing, viewing and/or displaying selected portions of digital content in accordance with the user's preferences.

### BACKGROUND

Desktop document processing programs (whether downloadable to a personal computer or available as a web/cloud service) have rigid templates and offer limited options for outputting such as, for example, printing, displaying, or sending (e.g. via email) content of a document.

Several commercially available products today have some capability to print or output selected portions of a document. An example of a document processing system that is well-known in the art is Microsoft Word. Using Microsoft Word a user can choose to print certain pages or a specific page range. However the user is not able to select additional options, such as adding multiple start and stop points within the document for printing only selected areas.

Historically, options on what a user can select to print has been limited. A user may select from a small list of previously defined options. FIG. 1 shows a list of currently available predefined options for printing, such as selecting a subset of pages within a document to print, the number of copies to print, the color (black and white or in color), layout (portrait or landscape), paper size to print on, selecting the number of pages per sheet, margins, scale, or whether to print headers & footers or background graphics.

In the current state of the art, if a user wants to print multiple sections within a document the user has to manually copy and paste each section into another document for printing. This is tedious, time consuming and unnecessary. This is also a limitation in many other products such as, for example, PDF documents, web pages, source code, and web search results.

Similarly, in spreadsheet applications such as Microsoft Excel a user may select a print area such as a specific column or row or group of columns or rows. However, this option is still limiting and does not allow users to choose printing based on other criteria such as printing cells, columns, or rows with specific words or phrases, fonts, values, conditions or other criteria.

The invention does not need to be limited to physically printing on paper. In an increasingly paperless environment, many users are viewing documents (whether in WORD, PDF or HTML) on screens such as a television, PC, laptop, tablet, smartphone, etc. However, the same limitations for printing and viewing apply. For example, a user may want to view a small subset of a page, pages that only contain certain words or phrases, only cells that contain numbers or look at only values greater or less than a threshold on a spreadsheet, etc. Currently a user must manually search for these specific criteria and create a document to view. If a user wishes to search for specific words or phrases, they may do so; however, the document shown will still include the entire document and will not allow the user to, for example, show only paragraphs or sentences including only those words or phrases without all other pages, paragraphs or sentences in between. This is time consuming and cumbersome especially when a user needs to show something on the fly such as during a presentation or when a user has a limited screen size in which to display such as on a cell phone.

Similarly, with ever increasing usage of video conferencing, screen sharing, and text messaging, being able to quickly and dynamically display only portions of a document or screen are becoming more important. For example, a user while sharing a screen wishing to show a portion of a document can only show the entire document and point with a pointer such as a mouse to sections within the document. Similarly, users wishing to send portions of a document via email or text message currently must take screen shots and/or crop each section they wish to send and then manually add each section into an email or text message prior to sending. This is also time consuming and adds many additional steps.

This invention offers a variety of user options for selecting portions of digital content for outputting to improve productivity. A further advantage is that the user is able to reduce the amount of paper needed for printing.

Another advantage of the present invention is that it can be implemented by the user without any prior knowledge of programming or background in using database commands.

All features disclosed herein can be integrated into desktop document processing software (e.g., Microsoft Word or Apple Pages), a web-browser (e.g. Google Chrome or Apple Safari), printer drivers, or any other graphical user interface (“GUI”) comprising a dialog box/wizard.

### SUMMARY

According to one aspect of the present invention, a method of outputting digital content is provided. Digital content such as word processing documents, spreadsheets, emails, pdf files, power point presentations, webpages, source code, or applications running a program such as screen sharing applications, may be analyzed. Based on the type of digital content, options for outputting may be provided to a user based on the type of digital content and on the available user preferences. The user then selects portions of the digital content to include or exclude based on the user preferences selected.

In one embodiment, outputting may be printing to a printer or printing to a pdf file, or printing to generate a webpage automatically in HTML. In another embodiment outputting may be displaying via screen share on a computer, or displaying on a phone during a cell phone video conference, or displaying on a presentation dynamically during a presentation. In yet another embodiment, outputting may be sending via text message or sending via email

In another embodiment, a user preference is selecting viewing options during a tracked changes version in a program. User preferences selected may be any one or combination of viewing comments, changes, and/or deletions from all users or a subset of users. In another embodiment, user preferences selected may be displaying copies of the document in a comparable mode allowing viewing of the copies of the document include appropriate spacing for comparison viewing.

In yet another embodiment, the elements digital content may be any or a combination of font, formatting (bold, italics, underline, etc.) specific words or phrases, values, quotes, quotes from a specific person, images, images containing different combinations such as people or places, images that don't contain something or someone specific.

In yet another embodiment, a user may choose to include or exclude portions such as “boilerplate language”.

In yet another embodiment, a spreadsheet or chart may be outputted in addition to digital content elements selected. For example, the chart may include statistical data related to the content being outputted. The statistical data may include data related to one or any combination of words, phrases, pages, chapters, sections, or terms in close proximity to a word or phrase.

In yet another embodiment, a user preference is to select code within the digital content to selectively output portions of the content. In one example, the code is HTML code with tags that may be selected to define sections to be outputted. In another example, the content to be analyzed is source code. The source code may be analyzed for any one or combination of comments, specific language, logical blocks of code, loops, function name, class, variable, constant, etc.

In yet another embodiment, different portions of the digital content may be sent to different users. In one example, the digital content may be an attachment in an email or text message. In another example the different portions of the content may be displayed to different users during a video conference. In yet another example, redacted and unredacted versions of content may be sent to different recipients or shown in a message with different formatting for each recipient. In yet another example the content may be outputted to different users in file sharing systems.

### BRIEF DESCRIPTION OF THE DRAWINGS

FIG. 1 is an example of the current prior art with predefined limited printing options;

FIGS. 2A-B show a side-by-side document view in accordance with an embodiment of the present invention;

FIGS. 3A-B show a keyword-based print view in accordance with an embodiment of the present invention;

FIGS. 4A-B show a search result print view in accordance with an embodiment of the present invention;

FIGS. 5A-B show printing a webpage as a PDF document in accordance with an embodiment of the present invention;

FIG. 6 shows printing using HTML tags in accordance with an embodiment of the present invention;

FIG. 7 shows printing selected portions of source code in accordance with an embodiment of the present invention;

FIG. 8 shows attachments being assigned to recipients in accordance with an embodiment of the present invention;

FIGS. 9-11 show a redacted message in accordance with an embodiment of the present invention;

FIG. 12 shows printing messages in a conversation format being in accordance with an embodiment of the present invention;

### DETAILED DESCRIPTION

In the foregoing, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

In addition, specific embodiments may describe printing, displaying, or sending. It is understood that while an embodiment may describe one or another, it will also include all other forms of outputting such as printing (e.g. to a printer or pdf), displaying (e.g. during a video conference screen share or cellphone video conference), sending (e.g. via email or text message).

Further, while specific embodiments may describe, a document, spreadsheet, PDF, email, etc. it is understood that all embodiments described will include all forms of digital content.

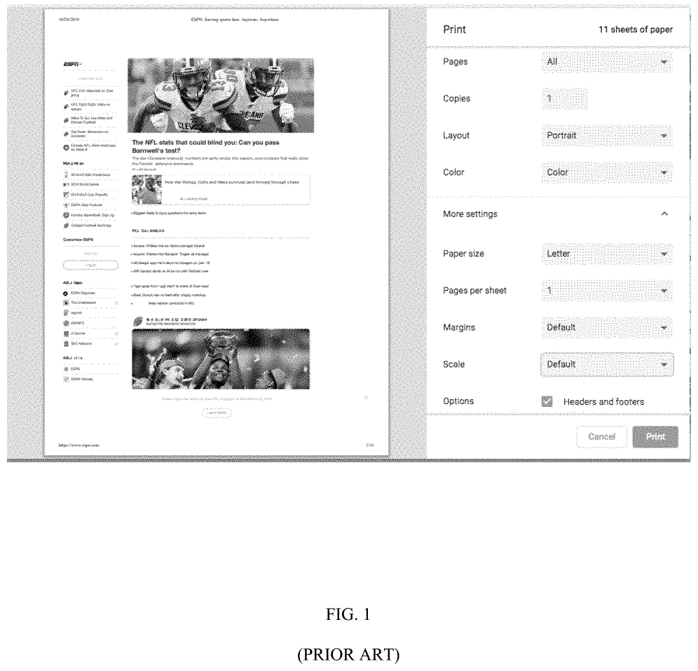

Referring to FIG. 1, an example of a well-known document processing system (Microsoft Word), is shown with predefined printing options. In this example, the user has very limited options for printing or outputting a document. The options shown in FIG. 1 include being able to print specific pages and/or print with or without headers and footers. The prior art lacks additional options for printing portions of the document for convenient viewing, such as the ability to only print selected portions of the document.

One tool commonly used in word processing programs such as Microsoft WORD includes tracked changes. This tool allows multiple users to review a document and make changes and comments within the document. The user is also able to view each change and decide if they would like to accept the change or revert back to the original version prior to the change. The user can then choose to print a list indicating each page where a change was made.

In one embodiment, the invention contemplates greater user options for viewing, outputting and/or printing changes made to a document. For example, the user can choose to view only the changes and/or comments made by certain individuals. Further, the user can choose to only view changes that resulted in content being added. Similarly, the user can choose to only view changes that resulted in content being deleted. These additional options allow the user to reduce the amount of tracked changes being viewed, thereby reducing the amount of space taken on a screen or amount of paper needed for printing.

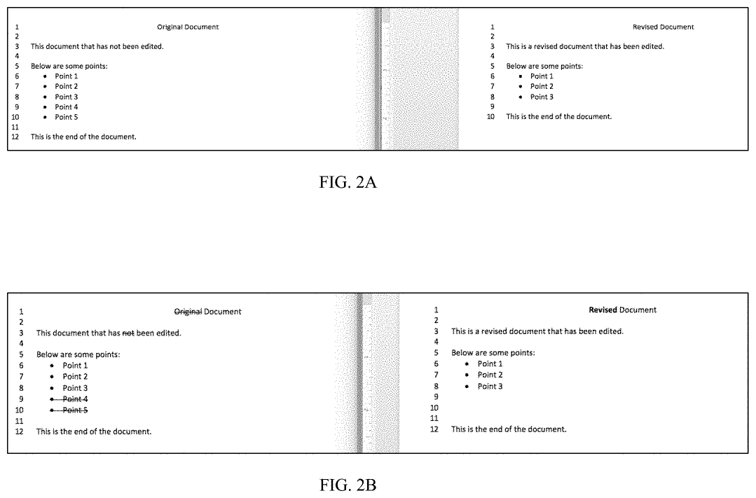

In another embodiment, the invention contemplates a way for the user to print two versions of a document side-by-side with greater readability. Currently, when multiple versions of a document are viewed side-by-side the spacing between the documents varies greatly due to the revisions that were made to each document. This results in the documents having different line spacing that is cumbersome and difficult for the user to read through when comparing the documents, as shown in FIG. 2A. In one embodiment, line spacing has been added to the documents such that the text can be easily compared line-by-line, as shown in FIG. 2B. Although the example shown demonstrates text being added and/or removed, the invention also applies to adding and removing graphics, charts, or the like. The invention is not limited to only adding line spacing. Other formatting, such as spacing between characters, words, sentences, or paragraphs can be added or removed to help the user compare the documents side-by-side.

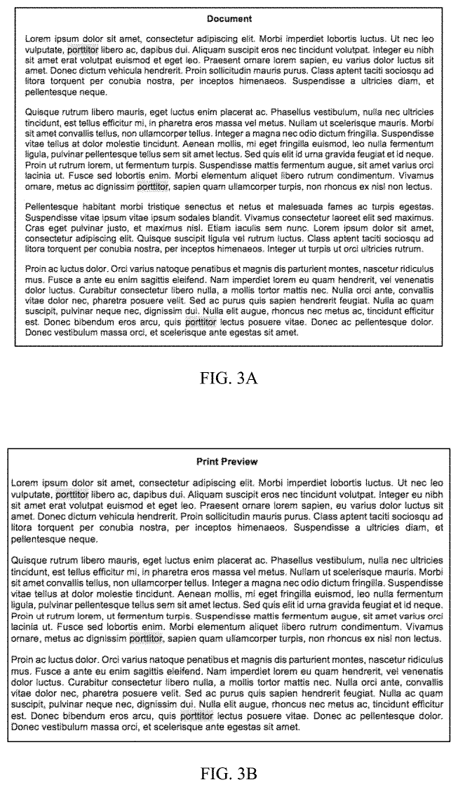

In another embodiment, the digital content may contain elements which the user may choose. For example, a user may choose to only print the portions of a document with a specific type of formatting such as only words or phrases that are bolded, italicized, underlined, or highlighted or some combination thereof. A user may also decide to only print sentences or paragraphs containing a word or phrase. The invention can also be applied to only printing the paragraphs that are adjacent to the word or phrase, or whole pages, sections, chapters, or subchapters that contain the specific word or phrase. For example, as shown in FIG. 3B the user can choose to only print the paragraphs that contain the phrase “porttitor”. Similarly, the user can choose to print all or some of the the paragraphs that include the specific words or phrase, along with a selected amount of characters, sentences, or paragraphs that appear before or after the word or phrase. Furthermore, the invention can recognize if the word or phrase is part of a list and if so, the entire list will be printed. Similarly, if the word or phrase is part of a chapter or subchapter, the entire chapter or subchapter containing the word or phrase can be printed. The invention can also be used to search for multiple words or phrases, with specific printing instructions for each word or phrase.

In another embodiment, the user can print specific steps within a manual. For example instead of choosing “Print pages 1-3, 5” the user can select “Print Steps 1-3 and 5”. Furthermore, when printing a document that is in outline form the user can select sections within the outline such as “Print I.A. and IV.B”.

In another embodiment, a user may choose to only print portions of a document that contain specific images, such as selecting only photos that include themselves within a photo album. For example, using the time, date, location and/or any other metadata that is associated with the photos, the user can choose to only print photos that were taken during a specific time period or at a specific location. Furthermore, using facial and/or object recognition software the user can choose to print only photos that they appear in or those photos that contain specific objects, such as a birthday cake.

In another embodiment, the invention may include an option to remove non-standard content from a document, such as a legal document or contract. Generally when legal contracts are drafted the majority of the content follows a standard template with similar or nearly similar content. As the contract is negotiated, content is added or modified as negotiated by both parties. The invention allows the user to select an option to remove the non-standard content from a document. This allows the user to quickly and easily see the sentences and/or paragraphs that have been modified and do not contain the usual content that is commonly used in standard agreements.

In another embodiment, if text in a document is too small or too large, its size may be adjusted automatically to a default size based on the user's setting in a browser, a word processing program and/or a printer driver (if applicable) before displaying and/or printing. This would be particularly useful for those with bad vision. The user may also have additional options such as changing the text color or specific words, phrases or paragraphs. The text may also be highlighted, the font or font style changed.

In another embodiment, the invention may include statistical information that may be displayed or printed along with the document. The statistical information may be presented as text, a table, or a chart. The statistical data may include the number of times a word or phrase appears, which pages the word or phrase appears, and/or the section, chapter, or subchapter in which the word or phrase appears. Additional words or phrases that usually appear alongside or in close proximity to the searched word or phrase may be included in the statistical information.

In another embodiment, the invention may automatically rotate a figure or a picture if not in a pre-specified orientation (e.g., upside down, landscape, tilted, not aligned with text, indented, etc.) for displaying, editing or printing.

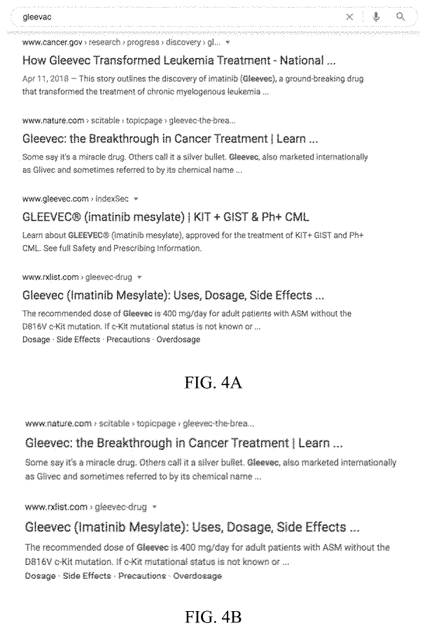

In another embodiment, the user is able to select and print individual search results from a list of search results, even if the list spans multiple pages. Current search engines, such as Google provide thousands of results spanning several pages. If the user wants to print only a few of the results from various pages there is no way for the user to do so. For example, as shown in FIG. 4A the search term “gleevac” returns several search results. The user can then select which search results the user wants to print, as shown in FIG. 4B. The user can select search results from different pages of search results. All the selected search results will be combined into one document for printing.

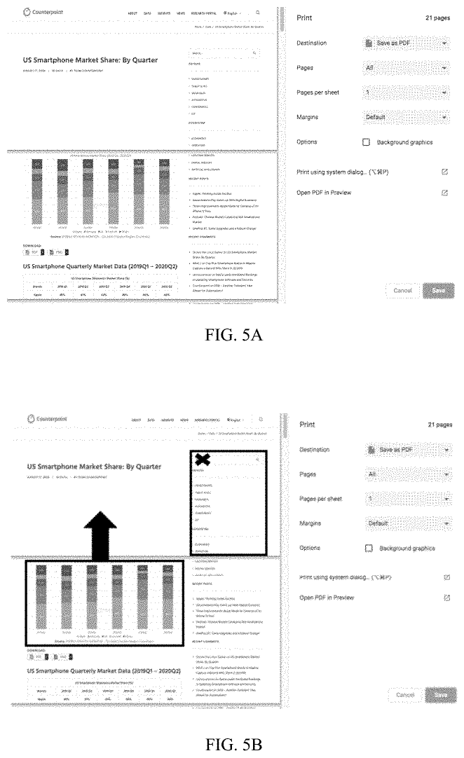

In another embodiment, the invention allows the user to easily select and/or deselect portions of a document for printing. This is especially helpful when trying to print a webpage. As shown in FIG. 5A, when the user wants to print a webpage as a PDF document, the resulting PDF document has misplaced content, excessive spacing, and unnecessary content. Using the invention, the user can use a GUI or other graphical toolbox (such as Print Preview), to select content to remove from printing. Similarly, the user can use the drag-and-drop feature to drag the table, as shown in FIG. 5A, up to the open space. This allows the user to print a webpage as a PDF document in a format that is more legible and also conserves paper. The user may also use any other application or module programmed to output the digital content in accordance with the user's preferences.

In a further embodiment the GUI-based dialog box/wizard can include a highlight tool, erase tool, and cursor tool. The highlight tool allows the user to select individual text objects, images or graphics that the user desires to be printed. Similarly, the erase tool allows the user to select text objects, images or graphics that the user does not want to be printed. The cursor tool allows the user to rearrange the objects using a drag-and-drop motion or a touch and glide motion. Alternatively, selection of objects may be done automatically such as using a search function.

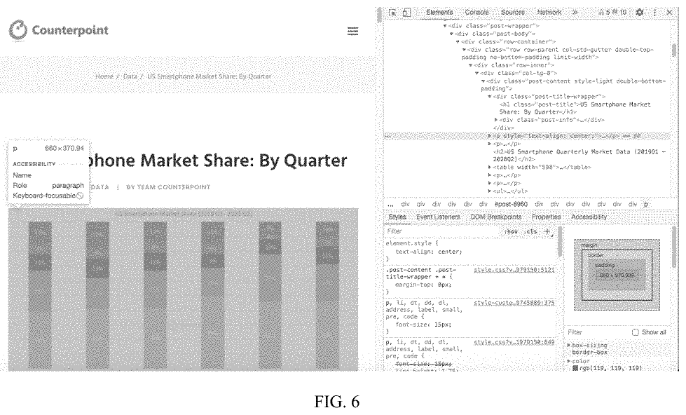

When printing a webpage into a PDF document the webpage contains metadata that could be used to help the user select, deselect, and/or move content for printing. The invention allows the user to choose which HTML tags the user wants to include or exclude from printing. As shown in FIG. 6, the user can select individual elements within the webpage using the HTML code within the webpage. The selection or deselection of content is done through a GUI or other graphical toolbox (such as Print Preview) so that the user does not have to have any background in programming. For example, the user can select to include content contained within the “<body>” tag and/or exclude content contained within the “<title>” tag. The user can also use the GUI or graphical toolbox to remove advertisements, pop-ups, buttons, icons, graphics, or any combination thereof. This is done by analyzing the HTML, tags, or any other software code. Alternatively, the invention may analyze code automatically and translate the code into language a user would understand. For example, instead of a <body> tag the invention may translate that to “main content”.

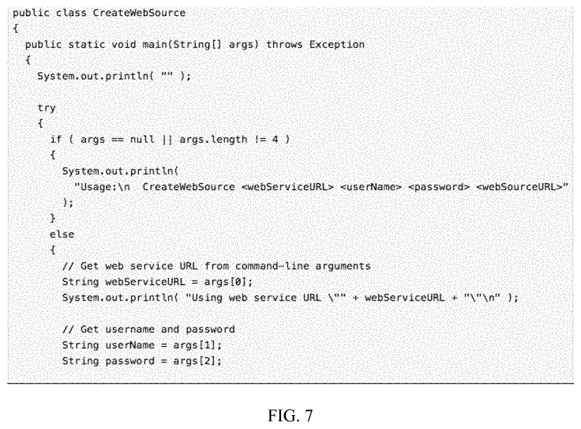

The invention may also be applied to printing selected portions of source code. Source code can span several thousand pages long, therefore printing source code can be cumbersome and time-consuming. In another embodiment of the invention, the user can search for keywords, functions, or variables within source code. The user can then choose to only print the blocks of code that contain the desired keywords, functions, or variables. For example, as shown in FIG. 7, the user can search for “CreateWebSource” to find all instances of the class CreateWebSource. The invention is able to parse the code to tell where the function opens and closes by, for example, reading the open bracket (“{”) and close bracket (“}”) within the source code so that the user can print only the source code contained within the class CreateWebSource. Furthermore, the invention allows the user to select to print with or without comments by including or deleting all instances of “//” followed by the comment text. Alternatively, a user may be able to search for blocks of code such as search for all loops within the code.

Outputting a document may be implemented not just on a printer but also via email, SMS, MMS, video conference screen sharing, cell phone video conferencing, etc. The present invention allows the user to send selected documents (e.g. digital content) or selected portions of a document as attachments without needing to send multiple messages or to maintain multiple copies of the selected document.

In current systems and applications, if the user wants to send an unredacted attachment to some recipients and a redacted attachment to a different set of recipients, the user must save a redacted document and a non-redacted document to their desktop. The user must then send separate emails, one containing the redacted document and another containing the non-redacted document. This is redundant, time consuming, and can result in sending the wrong version to an unintended recipient.

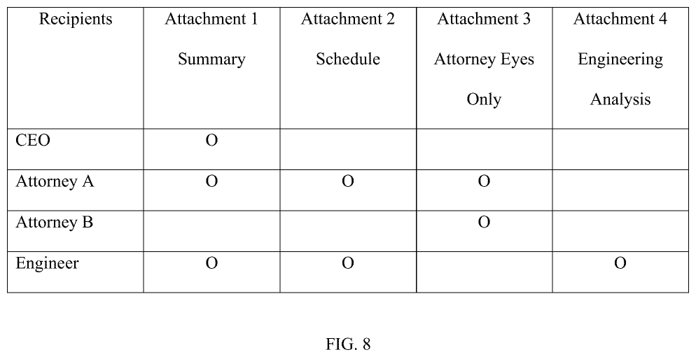

An advantage of the present invention is that different subsets of the original document can easily be sent to multiple recipients with varying security clearances. For example, in the present invention if the user wants to send a redacted version of a document to all employees within the organization and a non-redacted, “for attorney eyes only” version of the same document to all attorneys within the same organization the user could use, for example, a dialog box/wizard to select all the intended recipient(s) and select “unredacted” or “redacted” option. The advantage of sending multiple versions of the same document as opposed to sending different attachments is that the organization does not have to maintain multiple copies of the same attachment. As shown in FIG. 8, specific attachments may be assigned to recipients in line with a message such as with a drop down menu associated with a recipient's name and/or associated with the attachments. This may be implemented in any system of application where various users should receive or be shown different parts of a document such as during a video conference, in an email, in a text message, during a cell phone video

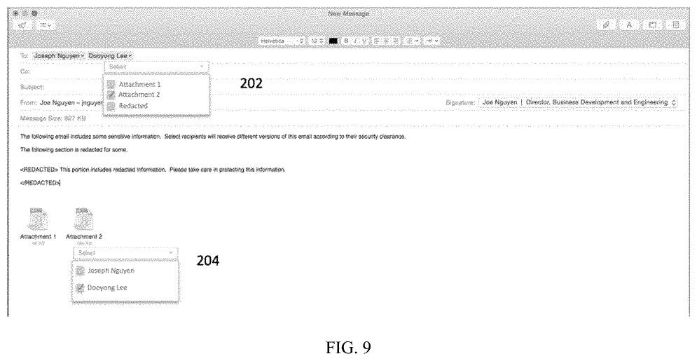

In addition, many times content may need to be redacted for specific recipients but not for others. In one embodiment, the invention allows a user to select recipients who will receive redacted versions of a message vs. recipients who will receive full versions of the message. This may be done, for example as shown in FIG. 9, with a drop down menu next to each recipient. Alternatively, this may also be done with a GUI-based dialog box similar to FIG. 8. Another variation of this embodiment is to vary the extent of redaction based on the recipient's clearance level or classification.

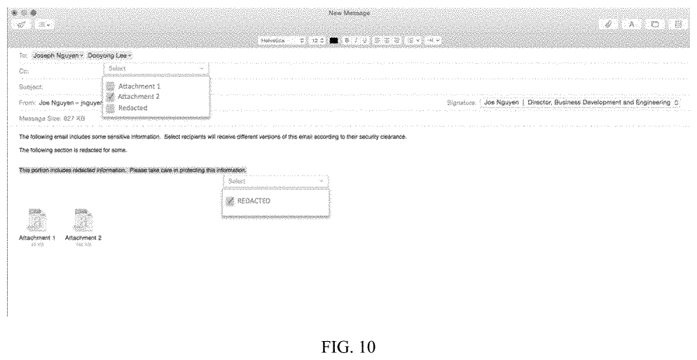

In order to determine which portions to redact, in one example, tags may be added to a message such as <REDACTED> to signify the beginning of a redacted section and </REDACTED> to signify the end of a redacted section. In another embodiment, redacted portions may be highlighted and a drop down menu may be used to quickly mark a highlighted section as redacted as shown in FIG. 10.

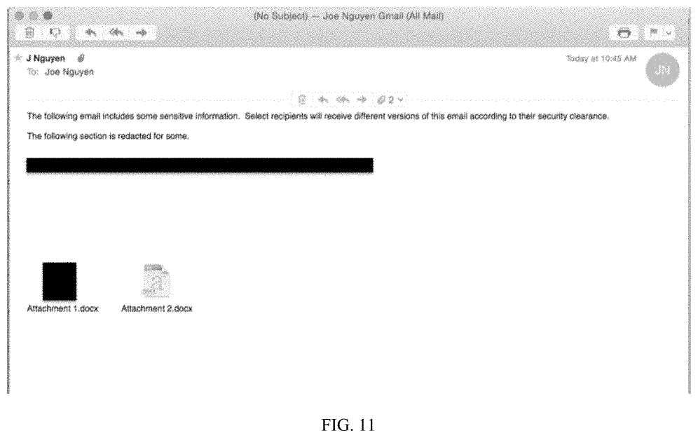

In another example, the message received by the recipient may include one or more portions that are “blacked out”, indicating to the recipient that portions of the message have been redacted, as shown in FIG. 11. A user may also select to not allow recipients to know that they are receiving a message that has been redacted. In such cases the message may be automatically reordered, lines deleted, etc. so that the email appears undisturbed.

In one embodiment, the system or application may be integrated with a GUI-based dialog box/wizard comprising a matrix, mapping a customized set of attachments to each recipient. To facilitate selection of attachments, attributes/title of each recipient and attributes/title of each attachment may be displayed in the dialog box. The user may then select attachments desired for each recipient.

In one embodiment, the attributes/titles may be further distinguished based on colors or icons, in addition to or in lieu of texts. For example, all documents for attorney eyes only may be displayed in red, all confidential documents in yellow, and all others in black. Icons may have unique shapes. Alternatively, icons may be miniaturized images of document contents.

In another embodiment, recipients may be displayed not only with titles but also organizations or companies they belong to, such that attachment selection can be facilitated. In another embodiment, recipients may be displayed graphically in an organization chart or using a unique icon for each organization or recipient.

In another embodiment, the GUI may comprise recipients on one side and the attachments on the other side, where lines can be drawn to map or associate attachments to each recipient. The lines may be further used to distinguish among recipients by using different patterns (e.g., solid line vs. dotted line, red line vs. yellow line, etc.).

Although the present invention has been described in the context of email processing, it can be appreciated to have broader applicability and does not need to be limited to email processing. The present invention may also be applicable to file sharing platforms or the like. For example, in a file sharing platform such as Dropbox, certain members of a group may only see a redacted version of a document, while others with full clearance may see the original, unredacted version of the same document. Alternatively, the invention may be applicable to other forms of communication, such as text messages, video conference messages, or the like. For example, where a presenter may wish to show different portions of a document with different people within a video conference or screen share.

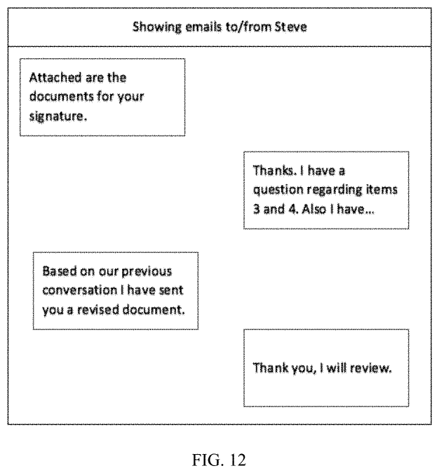

In yet another embodiment the email processing system allows the user to output and/or print emails in a conversation format. For example, as shown in FIG. 12 if the user searches for “Emails with steve@gmail.com” then all the emails to/from “steve@gmail.com” will appear. The user can then use the GUI-based dialog box to select “conversation view” so that the emails will be re-organized with all emails to Steve on the left side of the screen and all the emails from Steve on the right side of the screen, hence organized into a conversation format. The invention has intelligent processing to remove unnecessary text, such as email headers and signature blocks from the conversation. The user can also customize the view, such as by showing the first sentence of each email or limiting each conversation block to 100 characters. The user can also click on or use his/her finger to hide or unhide additional text within each conversation block. The user can then use the highlight tool and/or erasure tool on the GUI-based dialog box to select which conversation blocks the user wants to select or select for printing.

In current email messaging services when the user wants to forward an email to a recipient, he/she is limited to sending the entire email chain. In another embodiment, the invention allows the user to forward individual emails part of an email chain by selecting and/or deselecting individual emails within the email chain. For example, the user may want to delete certain emails in the email chain when forwarding to a client, while including all the emails in the email chain when forwarding to coworkers. The selection of which emails to include or not include when forwarding can be done entirely within the GUI/dialog box and reduces the amount of individual emails the user needs to compose.

In yet another embodiment, the invention allows an email sender to selectively prevent recipients from forwarding or printing an email, an email chain, and/or attachment(s).

1. A method of outputting digital content comprising:
analyzing the digital content,
providing options for outputting based on the type of digital content and on available user preferences,
outputting the digital content to the desired device based on the type of digital content and on user selection of available user preferences.

2. The method of claim 1 wherein outputting can be printing, displaying, sending.

3. The method of claim 2 wherein printing may be printing to a printer, printing to a PDF, printing to generate a webpage automatically in HTML.

4. The method of claim 2 wherein displaying may be displaying via screen share on a computer, or displaying on a phone during a cell phone video conference, displaying on a presentation dynamically during a presentation.

5. The method of claim 2 wherein sending may be sending via text message or sending via email.

6. The method of claim 1 wherein digital content may be a word processing software, a spreadsheet, an email, a pdf file, a power point presentation, a webpage, source code, or an application running a program.

7. The method of claim 1 wherein a user preference is selecting viewing options during a tracked changes version in a program

8. The method of claim 7 wherein in the user preferences selected may be any one or combination of viewing comments, changes, and/or deletions from all users or a subset of users

9. The method of claim 7 wherein the user preferences selected may be displaying copies of the digital content in a comparable mode.

10. The method of claim 9 wherein the comparable mode allows viewing of the copies of the digital content include appropriate spacing for comparison viewing.

11. The method of claim 1 wherein the outputted data is based on elements of the digital content and the elements may be any or a combination of font, formatting (bold, italics, underline, etc.) specific words or phrases, values, quotes, quotes from a specific person, images, images containing different combinations such as people or places, images that don't contain something or someone specific.

12. The method of claim 1 wherein a user preference is to select code within the digital content to selectively output portions of content.

13. The method of claim 12 wherein the code is HTML code with tags that may be selected to define sections to be outputted.

14. The method of claim 1 wherein the content to be analyzed is source code.

15. The method of claim 14 wherein the portions selected for outputted may be any one or combination of comments, specific language, logical blocks of code, or loops.

16. The method of claim 1 wherein different portions of the digital content may be sent to different users.

17. The method of claim 16 wherein the content may be an attachment in an email or text message.

18. The method of claim 16 wherein redacted and unredacted versions of the content may be sent to different recipients.

19. The method of claim 18 wherein the redacted and unredacted versions of the content may be shown in a message with different formatting for each recipient.

20. The method of claim 1 wherein data may be outputted to different users in file sharing systems.
